(19) United States
(12) Patent Application Publication
(10) Pub. No.: US 2008/0143552 A1
(43) Pub. Date: Jun. 19, 2008

(54) SENSOR ARRAY FOR DOWN-HOLE MEASUREMENT

(76) Inventors: Edgar R. Mallison, Wayzata, MN (US); Gregory C. Brown, Chanhassen, MN (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(21) Appl. No.: 11/610,471

(22) Filed: Dec. 13, 2006

(51) Int. Cl. G01V 3/00; G08B 1/00; G01V 3/38

(52) U.S. Cl. 340/853.1; 340/534; 340/854.9

(57) ABSTRACT

A sensor array includes an array of nodes coupled to an optical transmission line. The nodes include a transducer, and encoder, and a transmitter. The transducer senses an environmental condition such as temperature and pressure. The encoder encodes readings from the transducer by means of a characteristic frequency to indicate which node generated the reading. The transmitter transmits the encoded reading to a decoder located near the opening of the oil well, or other blind hole. Power is transmitted to the nodes through the transmission line. A photo-electric converter at the node converts the optical power to electrical energy that is stored to power the node.

### BACKGROUND OF THE INVENTION

Modern oil drilling requires accurate measurements of drilling conditions in order to maximize oil output. A modern oil well typically includes a main shaft extending down to oil bearing strata located from two to seven miles below the surface. Other subsidiary shafts may extend laterally from the main shaft to collect oil from different areas of the oil field. Valves connected to the subsidiary shafts control how much oil is extracted from each subsidiary shaft.

Measurements of temperature and pressure are typically used to evaluate the productivity of a well. Where multiple subsidiary shafts are used, measurements of temperature and pressure are used to determine which of the subsidiary shafts is most productive. The valves connecting the subsidiary shaft to the main shaft may then be opened or closed to maximize production. Accurate measurement of conditions at the bottom of the oil well is therefore critical to maximizing output.

The principle difficulty in measuring temperature and pressure lies in transmitting the measured values to the surface. Electrical wires extending two to seven miles to the bottom of the oil well will break under their own weight absent reinforcing cables, which occupy space and therefore limit flow through the shaft. At this length, cross-talk, noise, frequency dependent attenuation, chirping, and like effects, severely limit the bandwidth of an individual cable. In some systems, pressure waves are transmitted through pipes delivering drilling slurry to the bottom of an oil well. However, this method is limited to very low (one to two Herz) data rates and can therefore supply only limited information. Measurements are typically taken at multiple points along each subsidiary shaft and along the portion of the main shaft within the oil bearing strata. The amount of data transmission required is therefore very large.

In view of the foregoing it would be an advancement in the art to provide a system enabling accurate measurement of pressure and temperature in the oil-bearing strata of an oil well and providing high data transmission rates to the surface.

### SUMMARY OF THE INVENTION

The present invention provides systems and methods for retrieving temperature and pressure measurements from an oil well or other blind hole. In one embodiment, the invention includes an array of nodes coupled to an optical transmission line. The nodes include a transducer, and encoder, and a transmitter. The transducer senses an environmental condition such as temperature and pressure. The encoder encodes readings from the transducer to indicate which node generated the reading. The transmitter transmits the encoded reading to a decoder located near the opening of the oil well, or other blind hole. The encoded reading is analyzed by the decoder to determine the identity of the originating node and the reading.

In some embodiments, the nodes include a photo-electric converter and a collector. A transmitter coupled to the transmission line near the decoder emits a power signal. The photo-electric converter converts the power signal to electrical energy that is stored by the collector to power the transducer, encoder, and transmitter of the node.

In an alternative embodiment, a separate power transmission line supplies powers to the nodes and a data transmission line carries the encoded readings to the decoder. In yet another alternative embodiment, a separate transmission line extends to each node.al having a characteristic frequency component unique to each node.

### BRIEF DESCRIPTION OF THE DRAWINGS

Preferred and alternative embodiments of the present invention are described in detail below with reference to the following drawings:

FIG. 1A is a schematic block diagram of a sensor array in accordance with an embodiment of the present invention;

FIG. 1B is a schematic block diagram of an alternative embodiment of the sensor array of FIG. 1A in accordance with an embodiment of the present invention;

FIG. 2 is a schematic block diagram of an alternative embodiment of a sensor array in accordance with an embodiment of the present invention;

FIG. 3 is a schematic block diagram of an alternative embodiment of a sensor array in accordance with an embodiment of the present invention;

FIG. 4 is a schematic block diagram of an alternative embodiment of a sensor array in accordance with an embodiment of the present invention;

FIG. 5 is a process flow diagram of a method for sensing an environmental condition using a sensor array in accordance with an embodiment of the present invention; and

FIG. 6 is a process flow diagram of an alternative method for sensing an environmental condition using a sensor array in accordance with an embodiment of the present invention.

### DETAILED DESCRIPTION OF THE PREFERRED EMBODIMENT

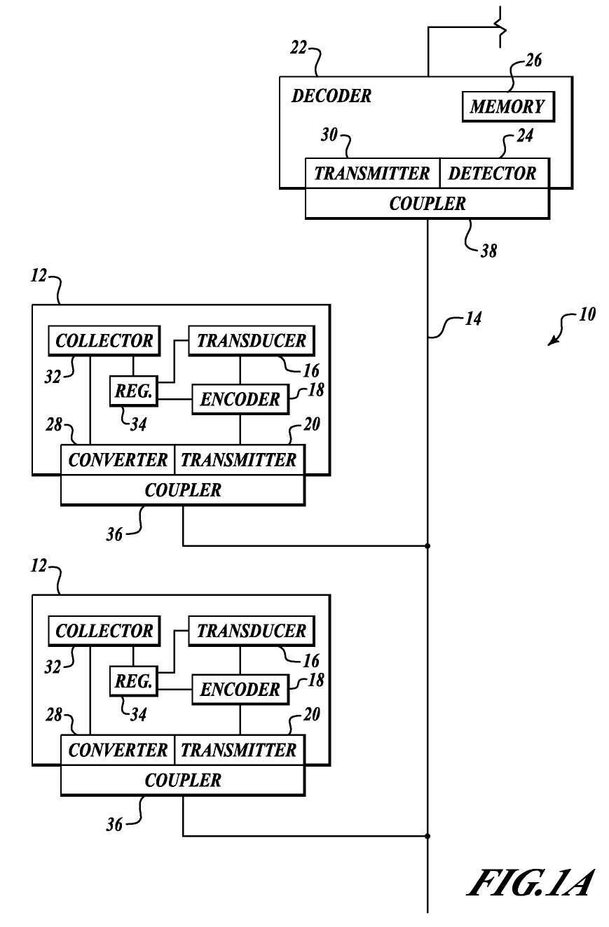

Referring to FIG. 1A, a sensor array 10 includes a plurality of nodes 12 each coupled to a data transmission line 14. The number of nodes 12 is variable, but may be up to many thousands on a single transmission line 14, depending on the data bearing capacity of the transmission line 14. The nodes 12 each include one or more transducers 16 suitable for measuring a physical property such as temperature, pressure, pH, movement, or the like. The output of the transducer 16 is encoded by an encoder 18 and the encoded signal is transmitted by a transmitter 20 by means of the transmission line 14 to a decoder 22 having a detector 24 for detecting the transmitted signal.

The encoder 18 typically encodes the output of the transducer 16 such that the encoded signal indicates which of the nodes 12 originated the signal. In the illustrated embodiment, the encoder 18 superimposes a signal communicating the value output by the transducer 12 on a carrier frequency assigned to the node 12. The encoder 18 superimposes the signal by means of frequency modulation, amplitude modulation, or like encoding means. The output of the transducer 16 may also be converted to a digital signal before or after encoding. In other embodiments, the encoder 18 creates a packet of data, such as an Internet Protocol (IP) data packet, containing a node identifier and the transducer output for transmission along the transmission line 14. The decoder 22 decodes the transmitted signal into a value representative of the reading from the transducer and a value indicating the node 12 that transmitted the reading. The values representing the reading and the originating node may be stored in a memory 26 of the decoder or may be transmitted to another device such as a general purpose computer. The node identifier may correspond to the location of the node 12. Accordingly, the decoder 22 may map the reading to a node position.

In the preferred embodiment, a photo-electric converter 28 is coupled to the transmission line 14. The converter 28 converts light emitted by a transmitter 30 near the decoder 22 into electrical current. The light emitted by the transmitter 30 may have a different wavelength than that emitted by the transmitters 20 of the nodes 12. Alternatively, they may be the same wavelength and the decoder 22 may distinguish between them based on frequency. The electrical current is stored in a collector 32, such as a capacitor or high-temperature battery. The collector 32 supplies electrical power to the transducer 16, encoder 18, and transmitter 20. One or more voltage regulators 34 may be interposed between the collector 32 and the transducer 16, encoder 18, and transmitter 20, such that current flow thereto is permitted only after a sufficiently large charge has accumulated in the collector 32 to both perform a measurement and transmit the results to the decoder 22.

In the embodiment of FIG. 1A, the transmission line 14 is an optical fiber. The nodes 12 are typically silicon based structures coupled to the transmission line 14. The transmitter 20 and converter 28 are connect to the transmission line 14 by means of a coupler 36 capable of withstanding the temperatures and pressures existing in oil wells. An example coupler 36 is made from glass fibers and metal which are both capable of higher temperature service. In the preferred embodiment, the transducers 16, encoder 18, and transmitter 20 are formed on a single silicon chip. In some embodiments they are formed on a silicon carbide chip. The transmitter 20 is typically formed as an LED formed on the chip and having a lens formed of glass capable of withstanding high temperatures and pressures. A coupler 38 couples the transmitter 30 and detector 24 to the transmission line 14. One or more optical couplers 34 connect the transmitter 20 and converter 28 to the transmission line 14.

In operation, the decoder 22 may listen serially at each of a range of possible frequencies to determine whether any of the nodes 12 is broadcasting a reading. Alternatively, the decoder 22 simultaneously detects signals from multiple nodes 12 and analyzes the composite signal according to carrier signal frequency to determine which of the nodes 12 is broadcasting a reading and to decode the reading.

Referring to FIG. 1B, in an alternative embodiment, a sensor array 40 has a decoder 42 having a transmitter 30 that transmits a signal having an intensity varying periodically according to a frequency associated with one of a plurality of nodes 44. The nodes 44 include a band-pass filter 46 interposed between the converter 28 and the collector 32. The band-pass filter 46 severely attenuates signals falling outside of a narrow band of frequencies. Accordingly, only the node 44 having a band-pass filter 46 tuned to the frequency of the signal transmitted by the transmitter 30 will collect a significant charge in the collector 32. A rectifier (not shown) may be interposed between the filter 46 and the collector 32 to convert the output of the filter 46 into a DC current.

In one embodiment, the transmitter 30 polls each node 44 by transmitting a power signal at the frequency corresponding to each node 44. As each node 44 is powered it will take a reading and transmit the reading to the detector 24. In the embodiment, of FIG. 1B, the encoder 18 is eliminated from each node 42. The decoder 42 includes an encoder 48 which steps through a number of frequencies, generating a signal at each frequency for sufficient duration to power the node 44 corresponding to the frequency. The signals received from each node 44 are then mapped to a node 44 according to the frequency of the signal generated by the transmitter 30 immediately preceding receiving the signal at the detector 24. Alternatively, delays between transmission of a power signal and receiving a reading are taken into account such that a reading received from a node 44 actually corresponds to a power transmission signal emitted prior to the power transmission signal immediately preceding receipt of the reading from the node 44.

Power transmission signals that do not correspond to a particular node 12 may nonetheless generate a small amount of current that passes through the band-pass filter 46. A dissipative element 50 may couple to the collector 32 to dissipate energy at a slow rate such that small amounts of current passing through the band-pass filter will be dissipated rather than causing the node 44 to emit a reading out of turn. For example, a resistor coupled to the collector 32 and to ground may serve as the dissipative element 50. When the power transmission signal has a frequency within the pass band of the band-pass filter, the rate of energy collection will exceed the rate of dissipation and the node 44 will take a reading and transmit the reading to the decoder 42.

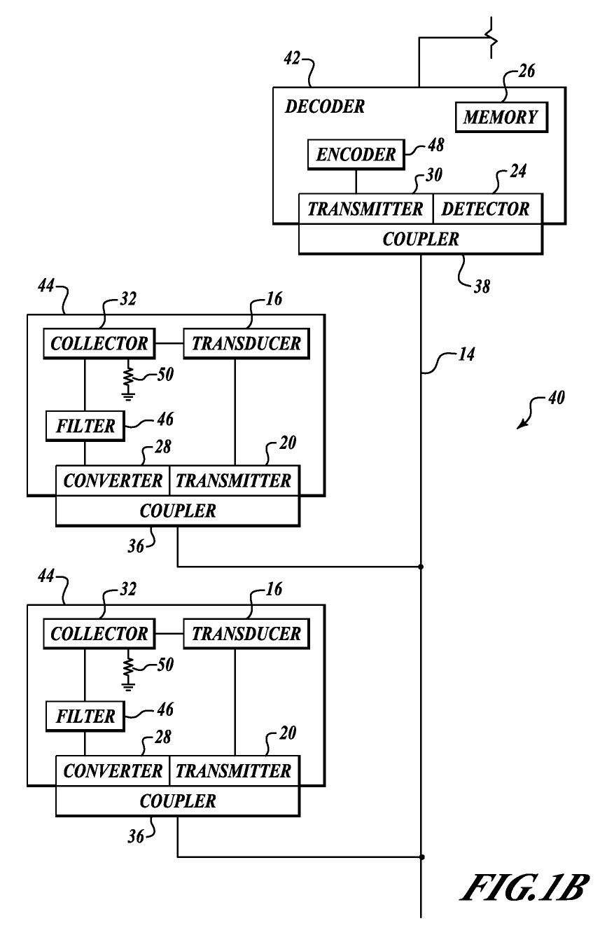

Referring to FIG. 2, in an alternative embodiment, a sensor array 52 includes a separate power transmission line 54 used to power each of a plurality of nodes 56 and the transmission line 14 is used to transmit readings from the nodes 56 to a decoder 58. The power transmission line 54 may be an optical transmission line or an electrical conductor. Where the power transmission line 54 is an electrical conductor, the current transmitted to the nodes 56 may be alternating or direct current. Where the power transmission line 54 is an electrical conductor the converter 28 and collector 32 may be eliminated.

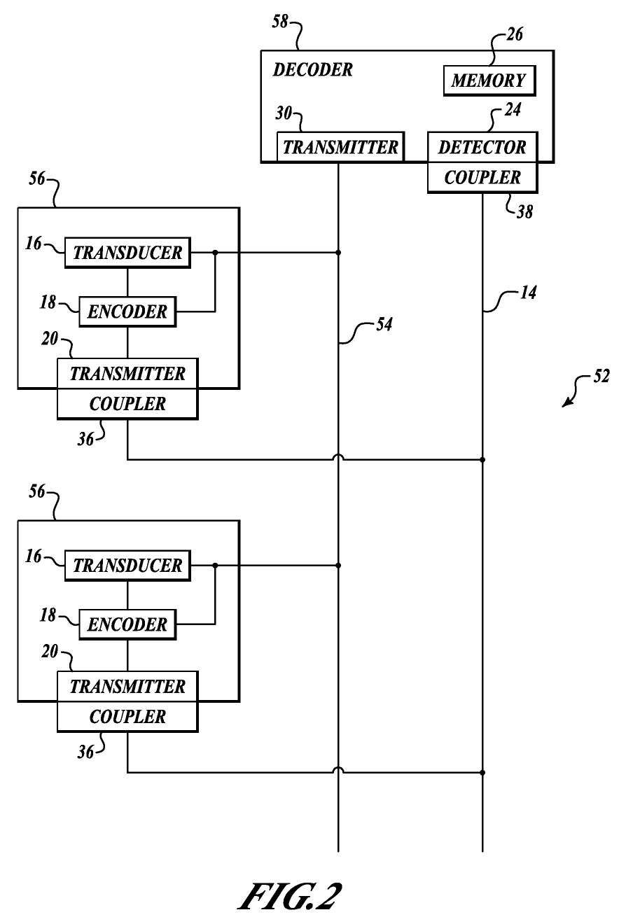

Referring to FIG. 3, in yet another alternative embodiment, an array 60 multiple transmission lines 14 are used. Each transmission line 14 may couple to a single node 62 or to multiple nodes 62. In the embodiment of FIG. 3, the nodes 62 may encode readings from the transducers 16 such that a decoder 64 may resolve which node 62 originated the reading. Alternatively, the decoder 64 may evaluate which transmission line 14 carried a signal in order to determine which node 62 originated the signal. In such embodiments, the encoder 18 may be omitted from the nodes 62. In the embodiment of FIG. 3, the node 62 may be substituted by a Resonant Integrated Micromachined (RIM) Acoustic Sensor coupled to the transmission line 14. Such that each transmission line 14 transmits an excitation signal to the RIM and transmits the output of the RIM back to the detector 24 of the decoder 64. The transmitter 30 of the decoder 64 may likewise be configured to generate an excitation signal for transmission to the RIM.

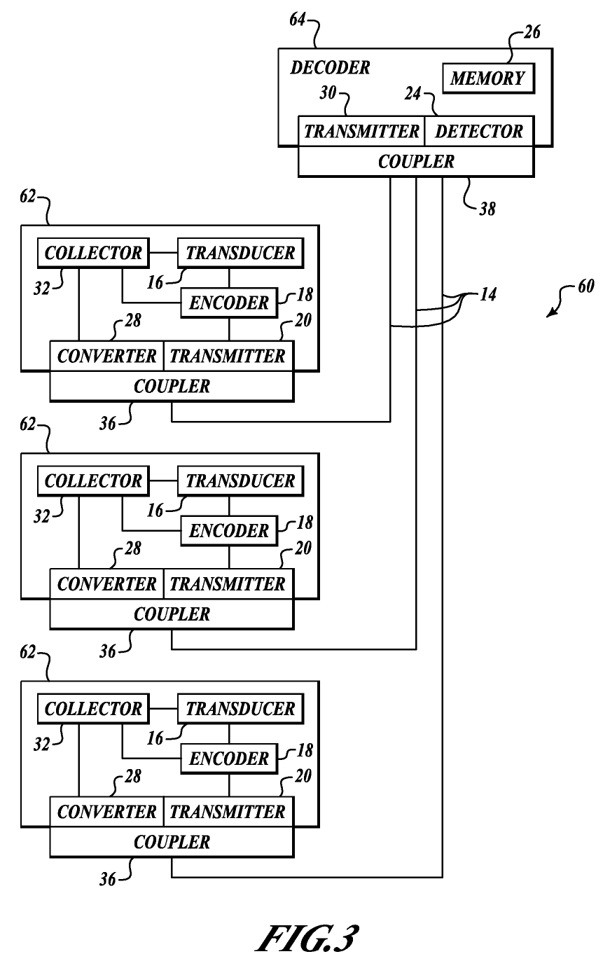

Referring to FIG. 4, in another alternative embodiment, an array 66 includes both a separate power transmission line 54 and a plurality of transmission lines 14 to transmit data and power between nodes 68 and a decoder 70. The embodiment of FIG. 4 may provide the advantage of eliminating the encoder 18, converter 28, and collector 32 from the nodes 68 thereby reducing the cost and complexity of the nodes 68.

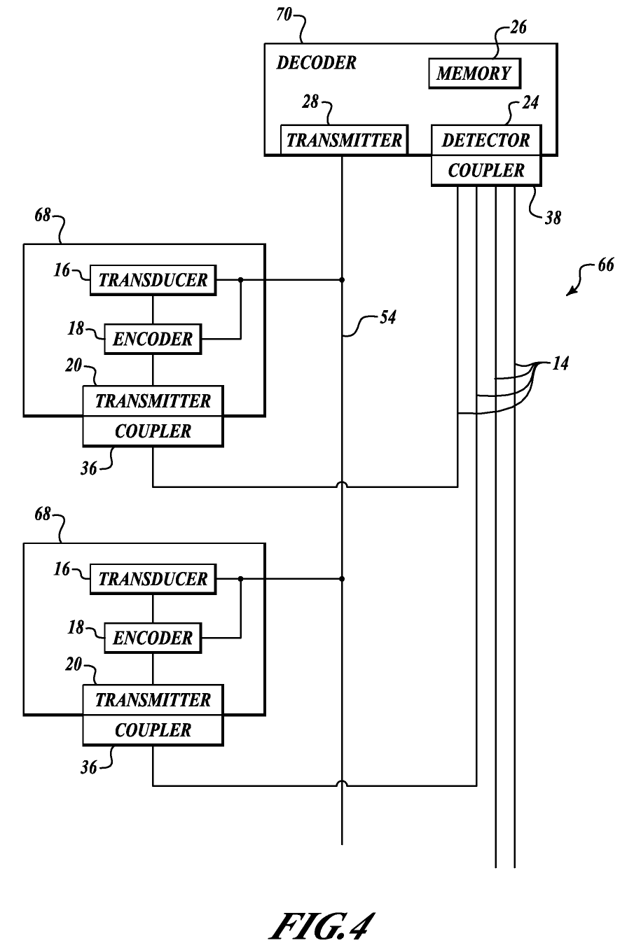

Referring to FIG. 5, a method 72 for using the sensor array 10 may include transmitting power to a node at block 74, such as by means of the transmission line 14. The power is collected at the node at block 76. Collecting power at the node may also include converting optical energy into electrical energy. However, in embodiments using a transmission line 14 embodied as an electrical conductor, conversion is not required. In embodiments of the sensor array 10 using separate power transmission lines, the collection step of block 76 may be omitted.

At block 78, the transducer senses an environmental condition such as temperature, pressure, or both, using power collected at block 76. At block 80 the output of the transducer is encoded and at block 82 the encoded reading is transmitted to the decoder. Both blocks 80 and 82 are also powered by the energy collected at block 76. At block 84 the encoded readings are decoded at the decoder in order to determine a value corresponding to the sensed environmental condition and to map the reading to the node originating the signal. The reading and the identity of the originating node may be stored at block 86.

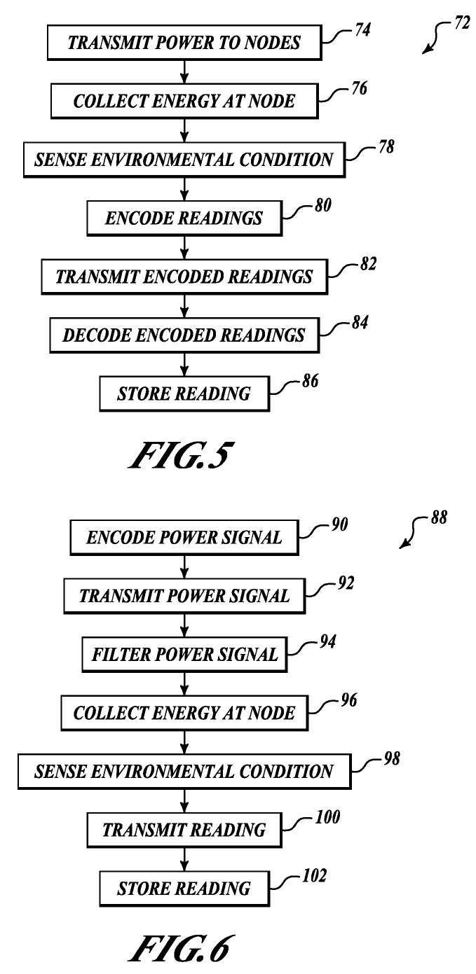

Referring to FIG. 6, a method 88 for using the sensor array 40 of FIG. 1B includes encoding a power signal at block 90, such as by generating a signal having a frequency mapped to a selected node. At block 92 the power signal is transmitted to the nodes. At block 94 the power signal is filtered such that only the selected node 12 having a band-pass filter 46 tuned to the frequency of the power signal will collect sufficient power to transmit a reading. At block 96 power passing through the filter 46 is collected, such as within a capacitor or battery. At block 98 an environmental condition, such as temperature, pressure, or both, is detected by the selected node. At block 100, data corresponding to the sensed environmental condition is transmitted to the decoder 22. At block 102 the data is stored mapping the data to the node corresponding to the encoded power signal.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A sensor array comprising:
a decoder comprising a detector and a power transmitter emitting a power signal;
an optical transmission line in communication the decoder effective to transmit the power signal; and
a plurality of nodes in communication with the transmission lines, the nodes each comprising:
a converter configured to convert the power signal to electrical energy;
a collector configured to store the electrical energy;
a transducer coupled to the collector and configured to sense an environmental condition;
an encoder in communication with the collector the transducer and configured to encode a reading from the transducer; and
a sensor transmitter in communication with the encoder and configured to transmit the encoded reading through the transmission line to the detector;
wherein the decoder is configured to decode the encoded readings from the plurality of nodes.

2. The sensor array of claim 1, wherein the encoder is further configured to generate a signal having a characteristic frequency component unique to each node.

3. The sensor array of claim 2, wherein the decoder detects the characteristic frequency component and maps the encoded signal to a sensor according to the characteristic frequency component.

4. The sensor array of claim 1, wherein the sensor transmitter includes a light emitting diode (LED).

5. The sensor array of claim 1, wherein the transducer is formed on a silicon carbide substrate.

6. The sensor array of claim 1, wherein the environmental condition is at least one of temperature and pressure.

7. The sensor array of claim 1, wherein the transducer is configured to sense both temperature and pressure.

8. A sensor array comprising:
a decoder comprising a detector;
an optical transmission line coupled to the detector effective to transmit optical signals to the detector;
an electrical power source;
a power transmission line coupled to the power source;
a plurality of nodes coupled to the optical transmission line and power transmission line, the nodes each comprising:
a transducer coupled to the power transmission line and configured to sense an environmental condition;
an encoder coupled to the power transmission line and configured to produce an encoded reading from the transducer output; and
a sensor transmitter coupled to the encoder and configured to transmit an encoded reading through the optical transmission line to the detector;
wherein the decoder is configured to decode the encoded readings from the plurality of nodes.

9. The sensor array of claim 8, wherein the encoder is further configured to generate a signal having a characteristic frequency component unique to each node.

10. The sensor array of claim 9, wherein the decoder detects the characteristic frequency component and maps the encoded signal to a sensor position according to the characteristic frequency component.

11. The sensor array of claim 8, wherein the sensor transmitter is a light emitting diode (LED).

12. The sensor array of claim 8, wherein the environmental condition is at least one of temperature and pressure.

13. The sensor array of claim 8, wherein the transducer is configured to sense both temperature and pressure.

14. A method for measuring down-hole conditions comprising:
inserting a plurality of nodes into a blind hole, the plurality of nodes each coupled to a transmission line and comprising a transducer configured to sense an environmental condition;
transmitting optical energy to the nodes through the transmission line;
converting the optical energy to electrical energy;
storing the electrical energy at the plurality of nodes;
sensing an environmental condition at the plurality nodes by means of transducers powered by the stored electrical energy;
encoding outputs from the transducers according to values uniquely identifying each of the plurality of nodes to produce an encoded reading;
transmitting the encoded readings through the transmission line to a detector by means of the stored electrical energy; and
decoding the encoded readings into values identifying one of the plurality of nodes and values corresponding to the outputs.

15. The method of claim 14, wherein encoding the reading comprises generating a signal having a characteristic frequency component unique to each node.

16. The method of claim 15, wherein decoding the encoded reading comprises mapping the encoded signal to a sensor position corresponding to the characteristic frequency component.

17. The method of claim 14, wherein the environmental condition is at least one of temperature and pressure.

18. The method of claim 14, wherein the transducer is configured to sense both temperature and pressure.

19. A method for measuring down-hole conditions comprising:
inserting a plurality of nodes into a blind hole, the plurality of nodes each coupled to first and second transmission lines and comprising a transducer configured to sense an environmental condition;
transmitting energy to the plurality of nodes through the first transmission line;
sensing an environmental condition at the plurality nodes by means of transducers;
encoding outputs from the transducers according to values uniquely identifying each of the plurality of nodes to produce an encoded reading;
transmitting the encoded readings through the second transmission line to a detector; and
decoding the encoded readings into values identifying one of the plurality of nodes and values corresponding to the outputs.

20. The method of claim 19, wherein encoding the reading comprises generating a signal having a characteristic frequency component unique to each node.

21. The method of claim 20, wherein decoding the encoded reading comprises mapping the encoded signal to a sensor position corresponding to the characteristic frequency component.
